(19) United States
(12) Patent Application Publication
(10) Pub. No.: US 2020/0137010 A1
(43) Pub. Date: Apr. 30, 2020

(54) SYSTEM AND METHOD FOR CREATING, MANAGING AND EXCHANGING DIGITAL BUSINESS CARDS BETWEEN COMPUTING DEVICES

(71) Applicants: Mohamed Samer Marmash, Abu Dhabi (AE); Muhammad Malik Sarfraz, Abu Dhabi (AE)

(72) Inventors: Mohamed Samer Marmash, Abu Dhabi (AE); Muhammad Malik Sarfraz, Abu Dhabi (AE)

(21) Appl. No.: 16/662,452

(22) Filed: Oct. 24, 2019

Related U.S. Application Data
(60) Provisional application No. 62/750,285, filed on Oct. 25, 2018.

(51) Int. Cl. H04L 12/58; G06Q 10/10; G06F 3/0482; G06F 3/0484

(52) U.S. Cl. CPC H04L 51/10; G06Q 10/101; G06F 8/60; G06F 3/0484; H04L 51/38; G06F 3/0482

(57) ABSTRACT

The present invention is a system (100) and a method for creating, managing and exchanging one or more digital business cards between computing devices (104) over a network (108). The method includes the step of facilitating authorized customers for creating digital business cards corresponding to a plurality of users by integrating fields through an editor module (204) connected to a website portal (116). The method includes the step of receiving and storing the digital business cards from the editor module through a data server (106). The method includes the step of presenting the digital business cards and facilitating the users to visualize the digital business cards through an algorithmic module (208) integrated within the computing devices (104). The algorithmic module (208) is downloaded by the users to facilitate the users to visualize the digital business cards. The method includes the step of populating the plurality of fields on detecting the download of the algorithmic module (208) in the computing devices through a graph application programming interface (API) module (210). The method includes the step of broadcasting an identification number of the computing devices corresponding to the users over the network for determining the computing devices having the same identification number present in a predefined distance through a broadcasting module (212). The method includes the step of displaying a plurality of paired names of the users corresponding to the computing devices of the users having the same identification number as broadcasted identification number through a display module (216). The method includes the step of facilitating the users for selecting the paired names of the users from the display module (216) for transmitting the digital business cards from the computing device that broadcasted the identification number to the computing device having the same identification number through a sharing module (218) via a predefined messaging protocol. The method includes the step of establishing communication between the computing devices that broadcasted the identification number with the computing devices having the same identification number through a communication server (306).

### FIELD OF INVENTION

The present invention relates to digital business cards, in particular to system and method for creating, managing and exchanging digital business cards between computing devices over a network.

### BACKGROUND

Typically, a business card is a tool for people to interact with the customers to introduce their products, services or themselves. Conventional physical business cards are ubiquitous and provide personal contact information including name, designation, contact number, email, and address. However, physical business cards tend to become voluminous to handle and carry around in large numbers and consequently will get lost or misplaced. Further, a user may unexpectedly run out of business cards at a large gathering such as a conference, and a business meeting where it may be difficult and expensive to get additional business cards to hand out.

US patent application number 2016/0371736 issued to Brett Turner discloses a method for sharing contact information between mobile computing devices. The contact information is converted from a proprietary format stored on a first mobile computing device to a non-proprietary graphical format. The non-proprietary graphical format can be any format commonly used by mobile computing devices to manage and process graphical data. However, the method for transferring data between mobile computing devices uses one or more electronic messaging methods, such as email, MMS, SMS, and other electronic messaging methods.

US patent application number 2015/0293893 issued to Damon Wayans discloses a method of implementing business card application. It displays a representation of a blank card on the touch-sensitive display. The method further detects the user's first finger contact with the touch-sensitive display. Further, in response to detecting the user's first finger contact, it displays a field on the representation of the blank card. Then the method comprises a step of detecting the user's second finger contact with the touch-sensitive display and in response to detecting the user's second finger contact adjusting position or dimensions of the field on the representation of the blank card. However, the method of implementing a business card application allows users to exchange their virtual business cards using their respective computing devices by initiating the exchange using a swiping gesture.

Moreover, with conventional business cards, the user may not get updated information about other users such as colleagues, friends, and clients. Further, the user may share the contact information with others using the mobile device with one or more electronic messaging methods, such as email, MMS, SMS, NFC, Bluetooth, and other electronic messaging methods. The only restriction to the aforementioned sharing mode is that only one person can receive the business card at a time. The mobile device provides no option to share the business card with multiple people at the same time.

Therefore, the existing systems and methods for the creation, management, and exchange of digital business cards are not quite satisfactory, and it has much room for improvements. There is, therefore, a need for a reliable, efficient and cost-effective system and method to create, manage and exchange digital business cards between computing devices over a communication network.

### SUMMARY

The present invention mainly deals with the technical problems existing in the prior art. In response to these problems, the present invention provides a system and method for creating, managing and exchanging digital business cards between computing devices over a network.

An aspect of the present invention relates to a system to create, manage and exchange digital business cards between computing devices over a network. The system includes a website portal, a data server, a processor, a memory, and a communication server. The website portal includes an editor module to facilitate one or more authorized customers to create digital business cards corresponding to a plurality of users by integrating a plurality of fields. The data server receives and stores the digital business cards from the editor module. The processor is connected with the data server and the computing devices corresponding to the users over the network. The memory is communicatively coupled to the processor, wherein the memory stores instructions executed by the processor. The memory includes an algorithmic module, a graph application programming interface (API) module, a broadcasting module, a display module, and a sharing module. The algorithmic module is integrated within the computing devices to present the digital business cards and facilitates the users to visualize the digital business cards. The algorithmic module is downloaded by the users to facilitate the users to visualize the digital business cards. The graph application programming interface (API) module is connected to the algorithmic module (208) to detect the download of the algorithmic module in the computing devices to populate the plurality of fields. The broadcasting module broadcasts an identification number of the computing devices corresponding to the users over the network to determine the computing devices having the same identification number present in a predefined distance. The identification number includes a universally unique identifier (UUID), a major value, and a minor value. The display module displays a plurality of paired names of the users corresponding to the computing devices of the users having the same identification number as the broadcasted identification number. The sharing module facilitates the users to select the paired names of the users from the display module to transmit the digital business cards from the computing device that broadcasted the identification number to the computing device having the same identification number through a predefined messaging protocol. The communication server is connected to the broadcasting module to establish a communication between the computing devices that broadcasted the identification number with the computing devices having the same identification number.

In another aspect of the present invention, the plurality of fields are selected from at least one of a business logo, name of the user, designation of the user, telephone number of the user, email of the user, and physical address of the user.

In a further aspect of the present invention, the broadcasting module broadcasts the identification number of the computing devices when at least one of a wireless network of the computing devices and a location service of the computing device is activated.

In a further aspect of the present invention, the communication server receives an array of the identification numbers of the computing devices of the users to minimize a continuous interaction of the computing devices with the communication server.

In yet further aspect of the present invention, the digital business cards are stored in the memory after the download of the algorithmic module in the computing devices to facilitate the users to visualize the digital business cards at a later time and exchange digital business cards.

In a further aspect of the present invention, the universally unique identifier (UUID) is pre-assigned to the algorithmic module.

In yet another aspect, the sharing module transmits the predefined messaging protocol to the identification number of the computing devices.

In yet another aspect, the predefined messaging protocol comprises an extensible messaging and presence protocol (XMPP).

An aspect of the present invention relates to a method for creating, managing and exchanging one or more digital business cards between a plurality of computing devices over a network. The method includes the step of facilitating one or more authorized customers for creating the digital business cards corresponding to a plurality of users by integrating a plurality of fields through an editor module connected to a website portal. The method includes the step of receiving and storing the digital business cards from the editor module through a data server. The method includes the step of presenting the digital business cards and facilitating the users to visualize the digital business cards through an algorithmic module integrated within the computing devices. The algorithmic module is downloaded by the users to facilitate the users to visualize the digital business cards. The method includes the step of populating the plurality of fields on detecting the download of the algorithmic module in the computing devices through a graph application programming interface (API) module connected to the algorithmic module. The method includes the step of broadcasting an identification number of the computing devices corresponding to the users over the network for determining the computing devices having the same identification number present in a predefined distance through a broadcasting module. The identification number comprises at least one of a universally unique identifier (UUID), a major value, and a minor value. The method includes the step of displaying a plurality of paired names of the users corresponding to the computing devices of the users having the same identification number as broadcasted identification number through a display module. The method includes the step of facilitating the users for selecting the paired names of the users from the display module for transmitting the digital business cards from the computing device that broadcasted the identification number to the computing device having the same identification number through a sharing module via a predefined messaging protocol. The method includes the step of establishing a communication between the computing devices that broadcasted the identification number with the computing devices having the same identification number through a communication server connected to the broadcasting module.

Accordingly, one advantage of the present invention is that it holistically captures corporate brand guideline design requirements while delivering a seamless automated mobile experience for users (employees).

Accordingly, one advantage of the present invention is that it allows authorized customers to design business card templates in line with corporate branding guidelines.

Accordingly, one advantage of the present invention is that it utilizes predefined APIs to ensure digital business cards are ready to share when the algorithmic module (software application) is downloaded.

Other features of the embodiments of the present invention will be apparent from accompanying drawings and from the detailed description that follows.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates a block diagram of the present system for creating, managing and exchanging digital business cards between computing devices over a network, in accordance with an embodiment of the present invention.

FIG. 2 illustrates a block diagram of the various modules within a memory of a digital business card creation, management and exchange device for creating, managing and exchanging digital business cards between computing devices over a network, in accordance with another embodiment of the present invention.

FIG. 3 illustrates an operational flow diagram of the interaction between the computing devices through an algorithmic module, in accordance with an embodiment of the present invention.

FIG. 4 illustrates an exemplary screenshot of the digital business card, in accordance with an embodiment of the present invention.

FIG. 5 illustrates an exemplary screenshot of the display module that depicts the users detected within the predefined distance enabled via a communication protocol (BLE and location services), in accordance with an embodiment of the present invention.

FIG. 6 illustrates an exemplary screenshot of the sharing module to share the digital business card by one or more sharing means, in accordance with an embodiment of the present invention.

FIG. 7 illustrates an exemplary screenshot to depict a notification window to accept or decline the digital business card shared from a user, in accordance with an embodiment of the present invention.

FIG. 8 illustrates an exemplary screenshot to depict that the received digital business cards are stored accordingly in respective folders, in accordance with an embodiment of the present invention.

FIG. 9 illustrates an exemplary screenshot to depict that the visualization of the received digital business cards, in accordance with an embodiment of the present invention.

FIG. 10 illustrates an exemplary screenshot presented to the authorized customers to upload user's data in a predefined format to manage the digital business cards of the users, in accordance with an embodiment of the present invention.

FIG. 11 illustrates an exemplary screenshot presented to the authorized customers to manually upload the user's data to manage the digital business cards of the users, in accordance with an embodiment of the present invention.

FIG. 12 illustrates another exemplary screenshot presented to the authorized customers to manually upload user's data to manage the digital business cards of the users, in accordance with an embodiment of the present invention.

FIG. 13 illustrates an exemplary screenshot to depict an employee list interface before the user's data is uploaded, in accordance with an embodiment of the present invention.

FIG. 14 illustrates an exemplary screenshot to depict the uploaded user's data, in accordance with an embodiment of the present invention.

FIG. 15 illustrates a flowchart of the method for creating, managing and exchanging one or more digital business cards between a plurality of computing devices over a network, in accordance with an alternative embodiment of the present invention.

### DETAILED DESCRIPTION

The present invention is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

Systems and methods are disclosed for creating, managing and exchanging digital business cards between computing devices over a network. Embodiments of the present invention include various steps, which will be described below. The steps may be performed by hardware components or may be embodied in machine-executable instructions, which may be used to cause a general-purpose or a special-purpose processor programmed with the instructions to perform the steps. Alternatively, steps may be performed by a combination of hardware, software, firmware, and/or by human operators.

Although the present invention has been described with the purpose of creating, managing and exchanging digital business cards between computing devices over a communication network, it should be appreciated that the same has been done merely to illustrate the invention in an exemplary manner and any other purpose or function for which explained structures or configurations could be used, is covered within the scope of the present invention.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this invention will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of the structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

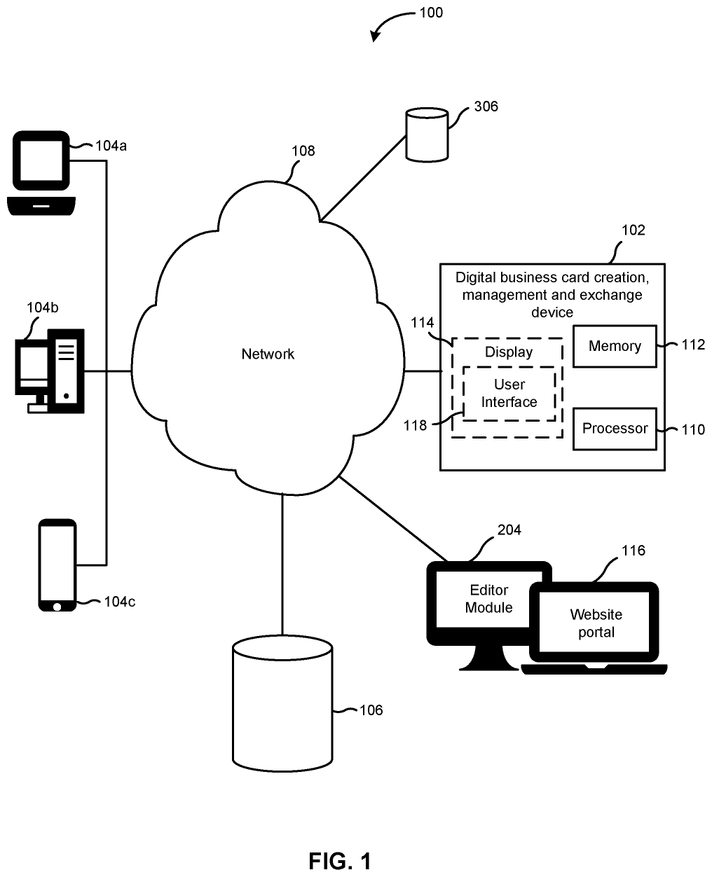

FIG. 1 illustrates a block diagram of the present system 100 for creating, managing and exchanging digital business cards between computing devices 104 over a network 108, in accordance with an embodiment of the present invention. The system 100 includes a digital business card creation, management, and exchange device 102, a website portal 116, a data server 106, a processor 110, a memory 112, and a communication server 306. It will be understood that the present system may be accessed by a plurality of users through one or more computing devices 104a, 104b, and 104c, collectively referred to as computing device 104 hereinafter, or applications residing on the computing devices 104. Examples of the computing devices 104 may include but are not limited to, a portable computer, a personal digital assistant, a laptop, a mobile phone, a smartphone, a handheld device, and a workstation.

Network 108 may be a wired or a wireless network, and the examples may include but are not limited to the Internet, Wireless Local Area Network (WLAN), Wi-Fi, Long Term Evolution (LTE), Worldwide Interoperability for Microwave Access (WiMAX), and General Packet Radio Service (GPRS).

The digital business card creation, management, and exchange device 102 enables the authorized customers such as an enterprise stakeholder or an employer to create, and manage the digital business cards and further facilitates the users such as employees of an organization to share the digital business cards with each other through their computing devices 104. The digital business card creation, management and exchange device 102 allows the enterprise stakeholders to design the digital business cards on the computing devices 104 and distribute the designed digital business cards to the computing devices 104 of the users (employees) through an application store that includes but not limited to an Apple® app store, Google Play® or a mobile device management.

In operation, when the user of computing device 104c, for example, wants to visualize the digital business cards, computing device 104c communicates the same with digital business card creation, management and exchange device 102, via network 108. The digital business card creation, management, and exchange device 102 may present the digital business cards as per the user's request.

The website portal 116 includes an editor module 204 to facilitate the one or more authorized customers or enterprise stakeholders to create the digital business cards corresponding to a plurality of users by integrating a plurality of fields. In an embodiment, the plurality of fields are selected from at least one of a business logo, name of the user, designation of the user, telephone number of the user, email of the user, and physical address of the user. In an embodiment, the website portal 116 is integrated with a desktop computer or a laptop, allows the authorized customer or enterprise stakeholders to capture/design their brand identity on the digital business cards according to their corporate brand guidelines. The designed approved digital business cards are “pushed or distributed” to the users (employees) of the contracted organization through the app store (Apple), google play or mobile device management configured with a data server 106 such as a cloud server.

The data server 106 receives and stores the digital business cards from the editor module 204. In an embodiment, the data server 106 may refer to a computing unit or a software framework hosting an application or a software service. In an embodiment, the data server 106 may be implemented to execute procedures such as, but not limited to, programs, routines, or scripts stored in one or more memories for supporting the hosted application or the software service. In an embodiment, the hosted application or the software service may be configured to perform one or more predetermined operations. The data server 106 may be realized through various types of application servers such as, but not limited to, a Java application server, a .NET framework application server, a Base4 application server, a PHP framework application server, or any other application server framework.

The processor 110 is connected with the data server 106 and the computing devices 104 corresponding to the users over the network 108. Processor 110 may include at least one data processor for executing program components for executing user- or system-generated requests. The users may include a person or an employee, a person using a device such as those included in this invention, or such a device itself. Processor 110 may include specialized processing units such as integrated system (bus) controllers, memory management control units, floating point units, graphics processing units, digital signal processing units, etc.

Processor 110 may include a microprocessor, such as AMD® ATHLON® microprocessor, DURON® microprocessor OR OPTERON® microprocessor, ARM's application, embedded or secure processors, IBM® POWERPC®, INTEL'S CORE® processor, ITANIUM® processor, XEON® processor, CELERON® processor or other line of processors, etc. Processor 110 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 110 may be disposed of in communication with one or more input/output (I/O) devices via an I/O interface. I/O interface may employ communication protocols/methods such as, without limitation, audio, analog, digital, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

The memory 112 is communicatively coupled to the processor 110, wherein the memory 112 stores instructions executed by the processor 110. In an embodiment, the memory 112 may be a non-volatile memory or a volatile memory. Examples of non-volatile memory may include, but are not limited to flash memory, a Read Only Memory (ROM), a Programmable ROM (PROM), Erasable PROM (EPROM), and Electrically EPROM (EEPROM) memory. Examples of volatile memory may include but are not limited to Dynamic Random Access Memory (DRAM), and Static Random-Access memory (SRAM).

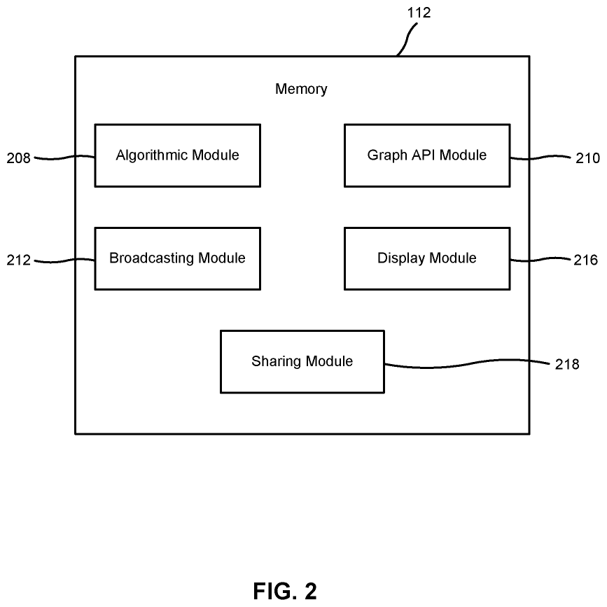

Memory 112 further includes various modules that enable the digital business card creation, management and exchange device 102 for creating, managing and exchanging one or more digital business cards between a plurality of computing devices 104 over a network 108. These modules are explained in detail in conjunction with FIG. 2. Digital business card creation, management, and exchange device 102 may further include a display 114 having a User Interface (UI) 116 that may be used by an administrator or authorized customers or enterprise stakeholders for creating and designing the digital business cards of the users by integrating the fields. Display 114 may further be used to display the user's data. The functionality of the digital business card creation, management, and exchange device 102 may alternatively be configured within each of the plurality of computing devices 104.

FIG. 2 illustrates a block diagram of the various modules within the memory 112 of a digital business card creation, management and exchange device for creating, managing and exchanging digital business cards between computing devices over a network, in accordance with another embodiment of the present invention. The memory 112 includes an algorithmic module 208, a graph application programming interface (API) module 210, a broadcasting module 212, a display module 216, and a sharing module 218. These modules include routines, programs, objects, components, data structures, etc., which perform particular tasks or implement particular abstract data types.

The algorithmic module 208 is integrated within the computing devices 104 to present the digital business cards and facilitates the users to visualize the digital business cards. The algorithmic module 208 is downloaded by the users to facilitate the users to visualize the digital business cards. In an embodiment, the algorithmic module 208 is an enterprise application that allows the users to receive the designed digital business cards from the application store through their computing devices 104. In an embodiment, the algorithmic module 208 is a software application which is executable on a plurality of operating systems such as Android, IOS, Windows, Linux, or the like.

The graph application programming interface (API) module 210 is connected to the algorithmic module 208 to detect the download of the algorithmic module 208 in the computing devices to populate the plurality of fields. In an embodiment, the graph API module 210 is Microsoft graph API to populate business card fields, i.e., automates populating of the fields once the users download the software application and sign in.

The broadcasting module 212 broadcasts an identification number of the computing devices corresponding to the users over the network 108 to determine the computing devices 104 having the same identification number present in a predefined distance. In an embodiment, the network 108 can be implemented as one of the different types of networks, such as Bluetooth low energy (BLE), an internet, or the like. The identification number includes a universally unique identifier (UUID), a major value, and a minor value. In an embodiment, the broadcasting module 212 broadcasts the identification number of the computing devices when at least one of a wireless network of the computing devices and a location service of the computing device 104 is activated.

In an embodiment, the universally unique identifier (UUID) is pre-assigned to the algorithmic module 208. The UUID, the major value, and the minor value provides a unique identifier to the computing device, and are the key components of all the digital business cards exchanged by the computing devices. Typically, the major and minor values are numbers assigned to the computing devices to identify them with greater accuracy than using UUID alone. In an embodiment, the UUID comprises a plurality of hexadecimal digits or alphanumeric values.

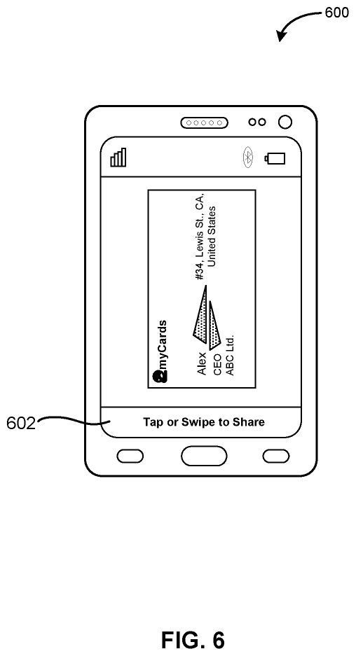

The display module 216 displays a plurality of paired names of the users corresponding to the computing devices of the users having the same identification number as the broadcasted identification number. Further, the display module 216 displays all the received digital business cards and allows the users to flip through the received digital business cards by an up/down swipe motion to access the backside of each card by using a left/right swipe gesture (shown in FIG. 6).

The sharing module 218 facilitates the users to select the paired names of the users from the display module 216 to transmit the digital business cards from the computing device 104 that broadcasted the identification number to the computing device 104 having the same identification number through a predefined messaging protocol. In an embodiment, the sharing module 218 transmits the predefined messaging protocol to the identification number of the computing devices 104. In an embodiment, the predefined messaging protocol comprises an extensible messaging and presence protocol (XMPP). The extensible messaging and presence protocol (XMPP) is a protocol utilized for streaming XML [XML] elements to exchange digital business cards and real-time location information.

In an embodiment, the digital business cards are stored in the memory 112 or local storage of the computing devices 104 after the download of the algorithmic module 208 in the computing devices to facilitate the users to visualize the digital business cards at a later time and exchange the digital business cards.

The communication server 306 is connected to the broadcasting module 212 to establish a communication between the computing devices that broadcasted the identification number with the computing devices 104 having the same identification number. In an embodiment, the communication server 306 receives an array of the identification numbers of the computing devices 104 of the users to minimize a continuous interaction of the computing devices with the communication server 306.

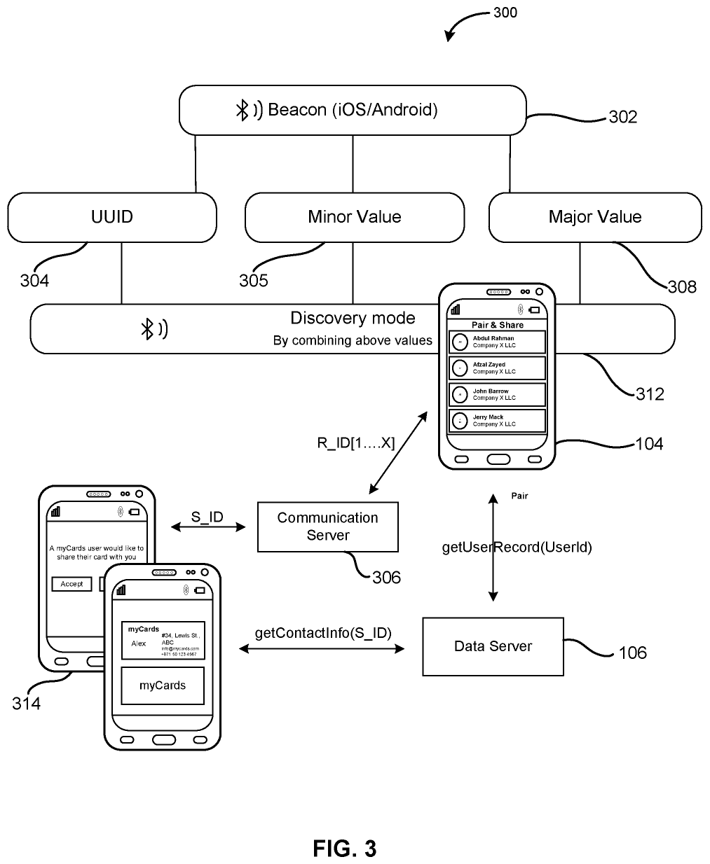

FIG. 3 illustrates an operational flow diagram 300 of the interaction between the computing devices through an algorithmic module, in accordance with an embodiment of the present invention. In operation, as soon as a user is signed in on the present software application, the computing device starts a step 302 of broadcasting the identification numbers of the users with a specific UDID 304, a minor value 305, and a major value 308. Thus the computing device 104 acts as a BLE device in this instance and functions only when Bluetooth is switched on. The computing device 104 then performs a step 312 of discovering nearby BLE devices 314 (receiver computing devices) with the specific UDID, which is assigned to the present software application. This step is performed only when the Bluetooth and the location services of the computing devices are switched on. The computing device and the BLE devices are communicating with each other through a communication server 306 or a cloud server 106 to exchange digital business cards.

The present disclosure further provides pseudocode used for discovering the BLE devices:

Start

Input UUID, MⱼV,

MV←UserID % 65535

MⱼV←UserID/65535

StartDiscovery(UUID,MV,MⱼV

Getlnfo( )←Fullname, company name

Repeat

End

When the computing device receives the nearby identification number of the user, it will request the cloud server 106 to fetch those names, and these names are shown accordingly. Once the names are fetched, they are stored locally so that if the user comes into range again after getting out of range, the present system does not have to fetch the name from cloud server 106 anymore.

The present disclosure further provides pseudocode used for pairing and sharing the digital business cards:

Start

Pair←R_ID[1. . . x]

Share←R_Ids[1. . . x]

Device X←Getnotified( )

getcarddata( )←Sender ID

Repeat Until Device X

End

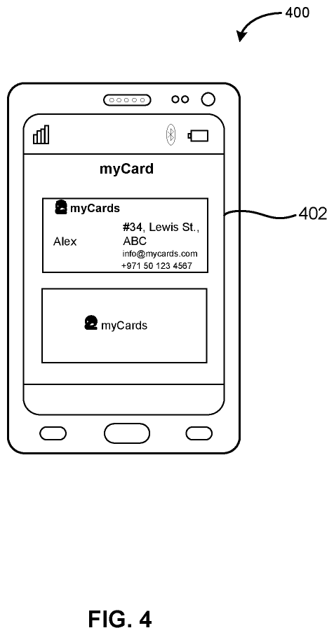

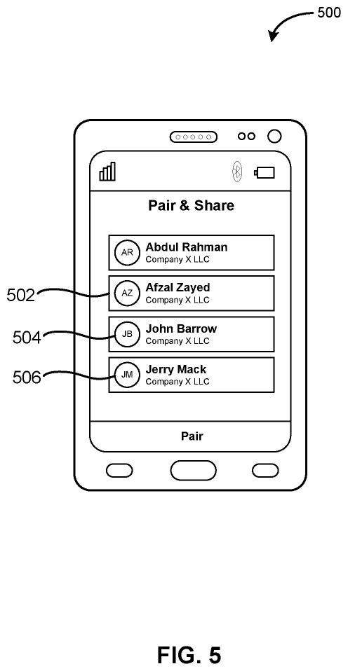

FIG. 4 illustrates an exemplary screenshot 400 of the digital business card, in accordance with an embodiment of the present invention. FIG. 5 illustrates an exemplary screenshot 500 of the display module that depicts the users detected within the predefined distance enabled via a communication protocol (BLE and location services), in accordance with an embodiment of the present invention. FIG. 6 illustrates an exemplary screenshot 600 of the sharing module to share the digital business card by one or more sharing means, in accordance with an embodiment of the present invention. Once the names of the users are displayed, the user can select multiple users 502, 504, and 506 from the pair and share the page and share his/her digital business card (shown in FIG. 6). In this scenario, the computing device sends an XMPP message to that identification number of the user. In one embodiment, the sharing means 602 is selected from at least one of a tap gesture and a swipe gesture received from the user.

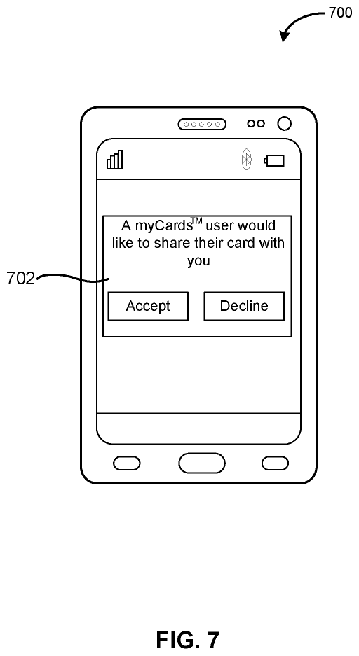

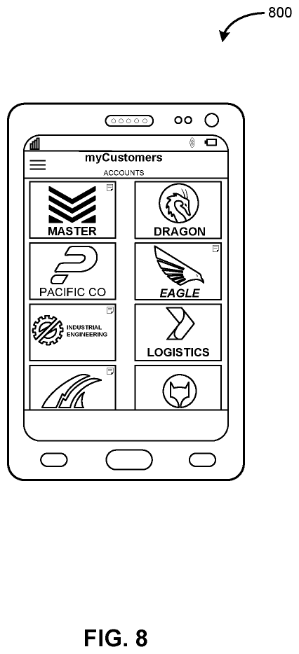

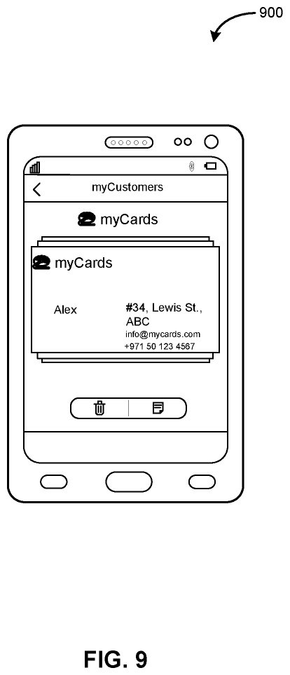

FIG. 7 illustrates an exemplary screenshot 700 to depict a notification window to accept or decline the digital business card shared from a user, in accordance with an embodiment of the present invention. FIG. 8 illustrates an exemplary screenshot 800 to depict that the received digital business cards are stored accordingly in respective folders, in accordance with an embodiment of the present invention. FIG. 9 illustrates an exemplary screenshot 900 to depict that the visualization of the received digital business cards, in accordance with an embodiment of the present invention. The received digital business cards of the customers will be displayed as shown in FIG. 9. The users can flip through the received digital business cards by an up/down swipe motion and can access the backside of each card by using a left/right swipe motion.

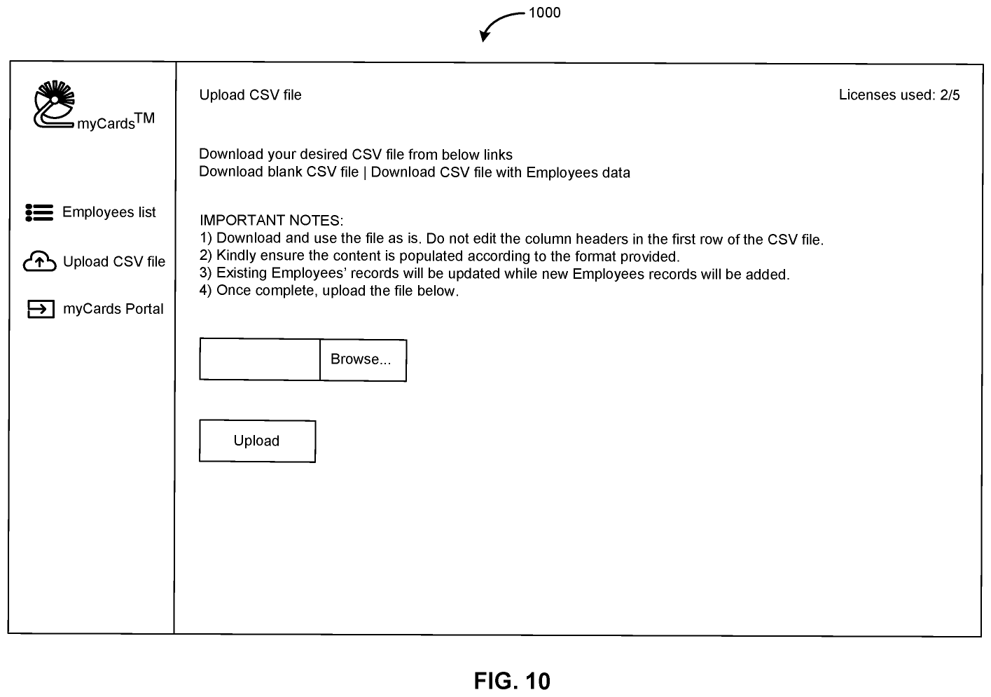

In an embodiment, the present system includes a contacts management system (CMS). The contacts management system (CMS) may allow the organizations or the authorized customers to manage the digital business card data of their employees via a data upload process. FIG. 10 illustrates an exemplary screenshot 1000 presented to the authorized customers to upload user's data in a predefined format to manage the digital business cards of the users, in accordance with an embodiment of the present invention. The predefined format includes but not limited to are .CSV format or .XLSX file format.

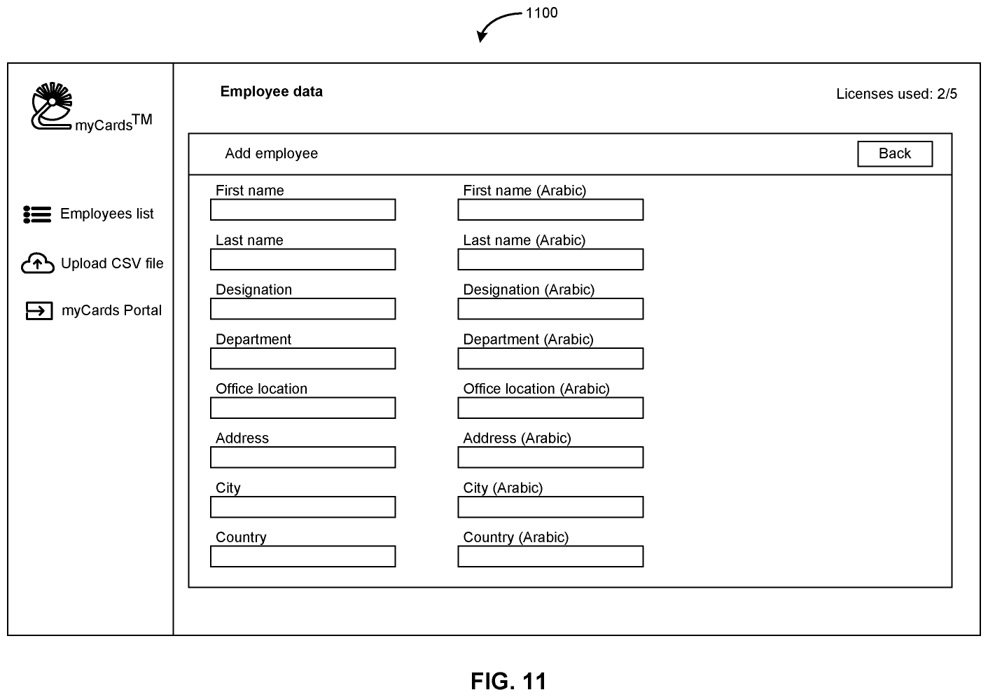

The data related to the employees can also be uploaded manually. FIG. 11 illustrates an exemplary screenshot 1100 presented to the authorized customers to manually upload the user's data to manage the digital business cards of the users, in accordance with an embodiment of the present invention.

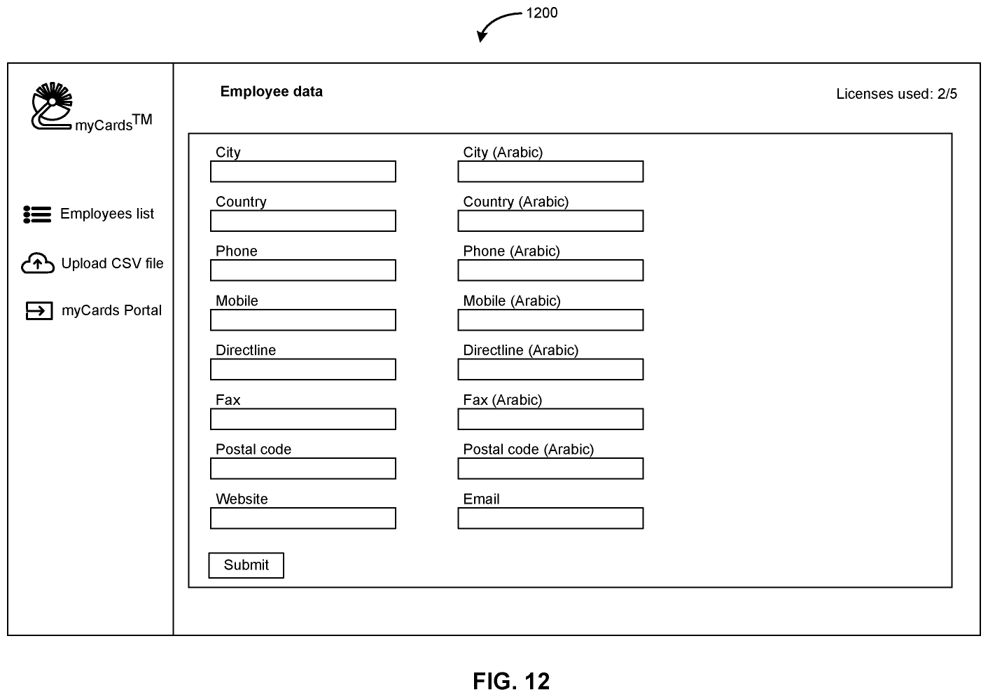

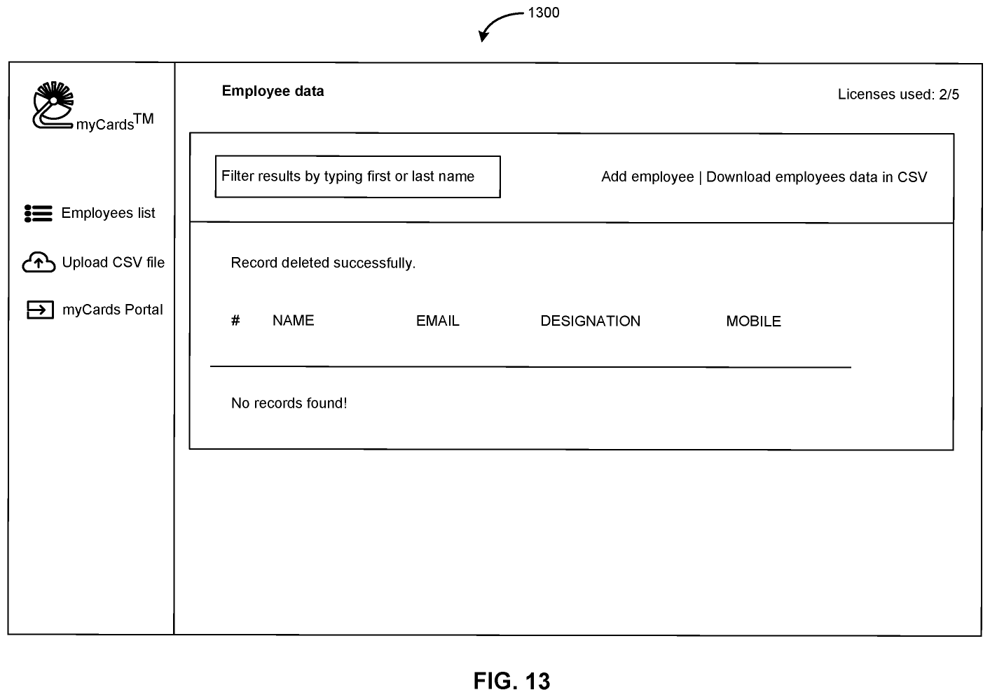

FIG. 12 illustrates another exemplary screenshot 1200 presented to the authorized customers to manually upload user's data to manage the digital business cards of the users, in accordance with an embodiment of the present invention. Once CSV or .XLSX file format is uploaded (bulk employee data upload), all the information or user's data are displayed as shown in FIG. 13. FIG. 13 illustrates an exemplary screenshot 1300 to depict an employee list interface before the user's data is uploaded, in accordance with an embodiment of the present invention. This will also allow the future employees to edit/update/delete the data as and when needed.

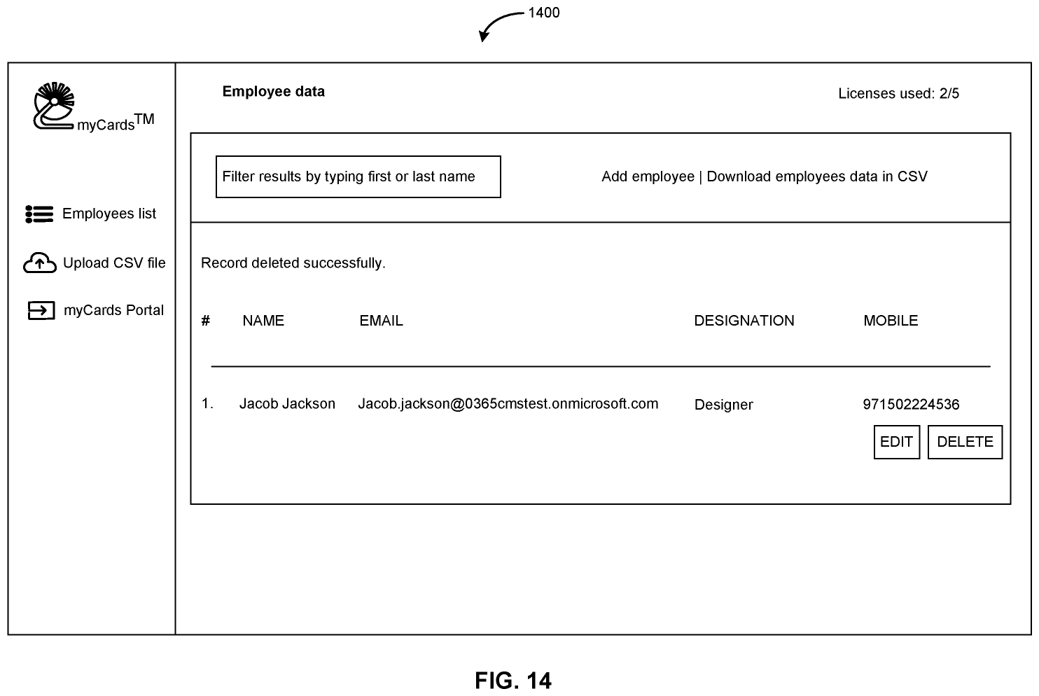

FIG. 14 illustrates an exemplary screenshot 1400 to depict the uploaded user's data, in accordance with an embodiment of the present invention. Once employee's data is uploaded and ready, the digital business cards of all the employees are shown on the algorithmic module in real-time at all times. As changes are made to the CMS, data on the algorithmic module would be updated accordingly for employees of the organization and all individuals' employees had shared their digital business cards via the pairing of the algorithmic modules and sharing communication tool/communication module.

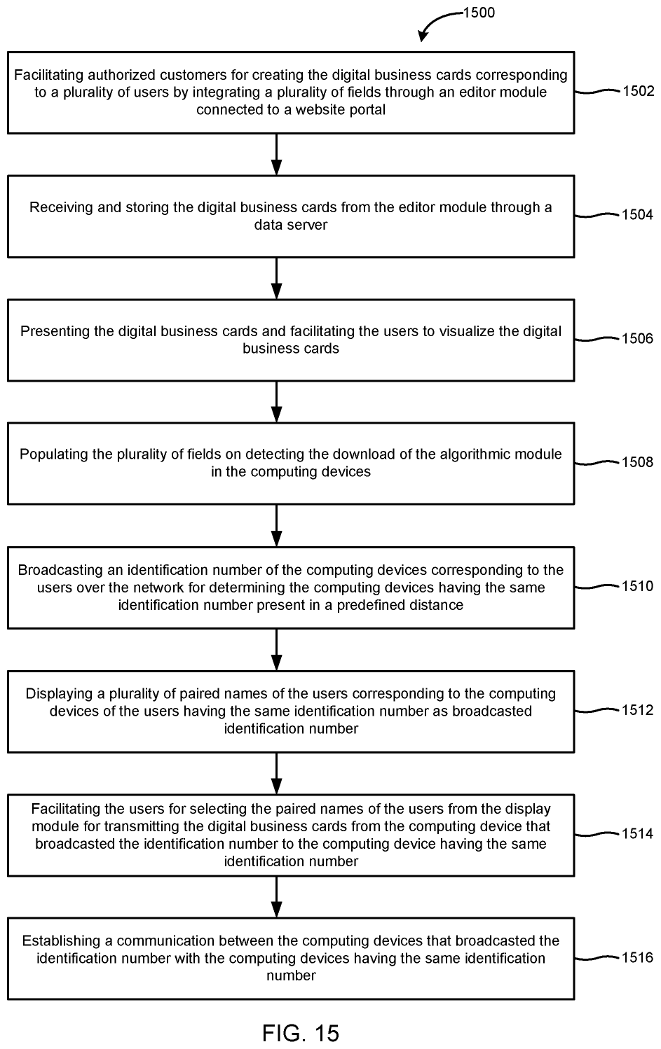

FIG. 15 illustrates a flowchart 1500 of the method for creating, managing and exchanging one or more digital business cards between a plurality of computing devices over a network, in accordance with an alternative embodiment of the present invention. The method includes the step 1502 of facilitating one or more authorized customers for creating the digital business cards corresponding to a plurality of users by integrating a plurality of fields through an editor module connected to a website portal. The method includes the step 1504 of receiving and storing the digital business cards from the editor module through a data server. The method includes the step 1506 of presenting the digital business cards and facilitating the users to visualize the digital business cards through an algorithmic module integrated within the computing devices. The algorithmic module is downloaded by the users to facilitate the users to visualize the digital business cards. The method includes the step 1508 of populating the plurality of fields on detecting the download of the algorithmic module in the computing devices through a graph application programming interface (API) module connected to the algorithmic module. The method includes the step 1510 of broadcasting an identification number of the computing devices corresponding to the users over the network for determining the computing devices having the same identification number present in a predefined distance through a broadcasting module. The identification number comprises at least one of a universally unique identifier (UUID), a major value, and a minor value.

The method includes the step 1512 of displaying a plurality of paired names of the users corresponding to the computing devices of the users having the same identification number as broadcasted identification number through a display module. The method includes the step 1514 of facilitating the users for selecting the paired names of the users from the display module for transmitting the digital business cards from the computing device that broadcasted the identification number to the computing device having the same identification number through a sharing module via a predefined messaging protocol. The method includes step 1516 of establishing a communication between the computing devices that broadcasted the identification number with the computing devices having the same identification number through a communication server connected to the broadcasting module.

Thus the present system and method automatically capture corporate brand guideline design requirements while delivering a seamless automated mobile experience for users. Further, the present system and method allow the authorized customers to design business card templates in line with corporate branding guidelines. Furthermore, the present system and method utilize the predefined APIs to ensure the digital business cards are ready to share when the algorithmic module is downloaded.

While embodiments of the present invention have been illustrated and described, it will be clear that the invention is not limited to these embodiments only. Numerous modifications, changes, variations, substitutions, and equivalents will be apparent to those skilled in the art, without departing from the scope of the invention, as described in the claims.

1. A system to create, manage and exchange one or more digital business cards between a plurality of computing devices (104) over a network (108), wherein the system comprising:
a website portal (116) comprising an editor module (204) to facilitate one or more authorized customers to create the digital business cards corresponding to a plurality of users by integrating a plurality of fields;
a data server (106) to receive and store the digital business cards from the editor module;
a processor (110) connected with the data server (106) and the computing devices corresponding to the users over the network (108); and
a memory (112) communicatively coupled to the processor, wherein the memory stores instructions executed by the processor (110), wherein the memory (112) comprising:
an algorithmic module (208) integrated within the computing devices (104) to present the digital business cards and facilitates the users to visualize the digital business cards, wherein the algorithmic module (208) is downloaded by the users to facilitate the users to visualize the digital business cards;
a graph application programming interface (API) module (210) connected to the algorithmic module (208) to detect the download of the algorithmic module (208) in the computing devices to populate the plurality of fields;
a broadcasting module (212) to broadcast an identification number of the computing devices corresponding to the users over the network to determine the computing devices having the same identification number present in a predefined distance, wherein the identification number comprises at least one of a universally unique identifier (UUID), a major value, and a minor value;
a display module (216) to display a plurality of paired names of the users corresponding to the computing devices of the users having the same identification number as broadcasted identification number; and
a sharing module (218) to facilitate the users to select the paired names of the users from the display module (216) to transmit the digital business cards from the computing device that broadcasted the identification number to the computing device having the same identification number through a predefined messaging protocol; and
a communication server (306) connected to the broadcasting module (212) to establish a communication between the computing devices that broadcasted the identification number with the computing devices having the same identification number.

2. The system according to claim 1, wherein the plurality of fields are selected from at least one of a business logo, name of the user, designation of the user, telephone number of the user, email of the user, and physical address of the user.

3. The system according to claim 1, wherein the broadcasting module (212) broadcasts the identification number of the computing devices when at least one of a wireless network of the computing devices and a location service of the computing device is activated.

4. The system according to claim 1, wherein the communication server (306) receives an array of the identification numbers of the computing devices of the users to minimize continuous interaction of the computing devices with the communication server (306).

5. The system according to claim 1, wherein the digital business cards are stored in the memory (112) after the download of the algorithmic module (208) in the computing devices to facilitate the users to visualize the digital business cards at a later time and exchange the digital business cards.

6. The system according to claim 1, wherein the universally unique identifier (UUID) is pre-assigned to the algorithmic module (208).

7. The system according to claim 1, wherein the sharing module (218) transmits the predefined messaging protocol to the identification number of the computing devices.

8. The system according to claim 1, wherein the predefined messaging protocol comprises an extensible messaging and presence protocol (XMPP).

9. A method for creating, managing and exchanging one or more digital business cards between a plurality of computing devices (104) over a network (108), wherein the method comprising steps of:
facilitating, by a digital business card creation, management, and exchange device (102), one or more authorized customers for creating the digital business cards corresponding to a plurality of users by integrating a plurality of fields through an editor module (204) connected to a website portal (116);
receiving and storing, by a digital business card creation, management and exchange device (102), the digital business cards from the editor module through a data server (106);
presenting, by a digital business card creation, management and exchange device (102), the digital business cards and facilitating the users to visualize the digital business cards through an algorithmic module (208) integrated within the computing devices (104), wherein the algorithmic module (208) is downloaded by the users to facilitate the users to visualize the digital business cards;
populating, by a digital business card creation, management and exchange device (102), the plurality of fields on detecting the download of the algorithmic module (208) in the computing devices through a graph application programming interface (API) module (210) connected to the algorithmic module (208);
broadcasting, by a digital business card creation, management and exchange device (102), an identification number of the computing devices corresponding to the users over the network for determining the computing devices having the same identification number present in a predefined distance through a broadcasting module (212), wherein the identification number comprises at least one of a universally unique identifier (UUID), a major value, and a minor value;
displaying, by a digital business card creation, management and exchange device (102), a plurality of paired names of the users corresponding to the computing devices of the users having the same identification number as broadcasted identification number through a display module (216);
facilitating, by a digital business card creation, management and exchange device (102), the users for selecting the paired names of the users from the display module (216) for transmitting the digital business cards from the computing device that broadcasted the identification number to the computing device having the same identification number through a sharing module (218) via a predefined messaging protocol; and
establishing, by a digital business card creation, management and exchange device (102), a communication between the computing devices that broadcasted the identification number with the computing devices having the same identification number through a communication server (306) connected to the broadcasting module (212).

10. The method according to claim 9, wherein the plurality of fields are selected from at least one of a business logo, name of the user, designation of the user, telephone number of the user, email of the user, and physical address of the user.

11. The method according to claim 9, wherein the broadcasting module (212) broadcasts the identification number of the computing devices when at least one of a wireless network of the computing devices and a location service of the computing device is activated.

12. The method according to claim 9, wherein the communication server (306) receives an array of the identification numbers of the computing devices of the users to minimize continuous interaction of the computing devices with the communication server (306).

13. The method according to claim 9, wherein the digital business cards are stored in the memory (112) after the download of the algorithmic module (208) in the computing devices to facilitate the users to visualize the digital business cards at a later time and exchange the digital business cards.

14. The method according to claim 9, wherein the universally unique identifier (UUID) is pre-assigned to the algorithmic module (208).

15. The method according to claim 9, wherein the sharing module (218) transmits the predefined messaging protocol to the identification number of the computing devices.

16. The method according to claim 9, wherein the predefined messaging protocol comprises an extensible messaging and presence protocol (XMPP).
